(19) United States
(12) Patent Application Publication
(10) Pub. No.: US 2024/0367457 A1
(43) Pub. Date: Nov. 7, 2024

(54) SECURE COLOR SELECTION APPARATUS

(71) Applicant: PPG Industries Ohio, Inc., Cleveland, OH (US)

(72) Inventors: Anahi L. Martinez, Victoria (AU); Rachel D. Lacy, Victoria (AU); Courtney J. Vanderlinde, Victoria (AU); Christopher J. Vellis, Victoria (AU); Jesus Pena Canton, New South Wales (AU)

(73) Assignee: PPG Industries Ohio, Inc., Cleveland, OH (US)

(21) Appl. No.: 18/293,428

(22) PCT Filed: Jan. 30, 2022
(86) PCT No.: PCT/US2022/014467

§ 371 Date: Jan. 30, 2024

Related U.S. Application Data
(60) Provisional application No. 29/801,807, filed on Jul. 30, 2021.

(30) Foreign Application Priority Data
Jul. 30, 2021 (AU) 2021104745

(51) Int. Cl. B44D 3/00; G06F 3/14; G06Q 20/20

(52) U.S. Cl. CPC B44D 3/003; G06F 3/1446; G06Q 20/20

(57) ABSTRACT

A color selection kiosk can comprise a kiosk body having a substantially wedge-shaped structure, where the web-shaped structure comprises a front surface and aback surface that form an acute angle at a bottom of the kiosk body. A holder in the form of an extension arm extends from the front surface of the kiosk body, and provides a physical attachment for both a digital display device and for a color reader. In one example, the extension arm can provide a conduit for electrical power to both the color reader and the digital display device. The kiosk body may further comprise one or more physical interfaces for holding one or more color reference chips, cards or color reference sheets, e.g., for device calibration purposes. The back surface of the kiosk body can provide an attachment interface for attachment to a support surface, such as a wall or other display structure.

### BACKGROUND OF THE INVENTION

### 1. Technical Field

The present invention relates to devices, computer-implemented methods, and systems for providing digital color selection in a retail space.

### 2. Background and Relevant Art

End users that desire purchase and application of coatings, such as paints for use in residential, automotive, or other purposes of interest, frequently encounter a difficult choice of either repainting an item from scratch, or attempting to match a previously applied coating that has changed over time. For example, the coating may have faded due to sunlight, or other wear and tear. The user may desire to match coatings applied to damaged portions of the article with the remaining, undamaged portions, or may desire to repaint portions of an area that were previously coordinated with other colors. Point of sale locations, such as a retail space, generally provide numerous coating matching schemes to assist users in selecting an appropriate coating and coating color.

Conventional coating matching systems, however, tend to employ color chips that a user can gather and compare against a home item, whether for direct matching or to identify complementary colors to previously applied coatings. Unfortunately, physical color chips provide a number of different difficulties in terms of accuracy and consistency relevant to the corresponding paint code, which may be exacerbated by the various color perception differences among individuals. More recently, coating manufacturers have implemented digital color identification instruments such as spectrophotometers, spectrometers, and colorimeters in connection with computer systems in an attempt to standardize coating color identifications, as well as to make the process more efficient. Typically, such uses are limited to industrial settings due to the cost of color identification instruments, as such devices tend to be cost-prohibitive to ordinary end users. Instrumentation used in retail locations tends to be limited to barcode and QR code readers.

### BRIEF SUMMARY

The present invention provides systems, methods, and computer program products corresponding to a color selection kiosk that enables ordinary end users to use otherwise cost-prohibitive color reading instrumentation. The color selection kiosk can comprise a kiosk body having a substantially wedge-shaped structure, where the web-shaped structure comprises a front surface and a back surface that form an acute angle at a bottom of the kiosk body. A holder in the form of an extension arm extends from the front surface of the kiosk body, and provides a physical attachment for both a digital display device and for a color reader. The color selection kiosk can be retrofitted to existing color displays in a retail space.

For example, a color selection kiosk for use in a point-of-sale location can include a kiosk body having a top, a bottom, a planar back surface, and a front surface that is angled relative to the back surface. In this case, the planar back surface and front surface form a wedge mounted against a support structure. The kiosk can also include a digital device displaying a graphical user interface, wherein the digital device is presented by a holder that extends from the front surface of the kiosk body. In addition, the kiosk can include a digital color reader communicably connected to the digital device. In this case, the color reader and the digital device are both physical secured and electronically connected to the kiosk body via the holder, and the color reader and the digital device are able to maintain continuous power for immediate use.

Similarly, a color selection system for use at in a point-of-sale location, can include a wall display comprising a plurality of surfaces joined to form a standalone unit. The plurality of surfaces can further include a front side surface having with at least one planar surface and at least one angled surface. The system can also include a kiosk body having a top, a bottom, a back surface, and a front surface that is angled relative to the back surface. The planar back surface and front surface of the kiosk body can form a wedge mounted against a support structure. In this case, the back surface of the kiosk body is mounted directly to either the angled surface or the planar surface of the wall display. Furthermore, the system can include a digital device displaying a graphical user interface, wherein the digital device is presented by a holder that extends from the front surface of the kiosk body. Still further, the system can include a digital color reader communicably connected to the digital device. In this case, the color reader and the digital device can both be physical secured and electronically connected to the kiosk body via the holder, and the color reader and the digital device are able to maintain continuous power for immediate use.

Additional features and advantages will be set forth in the description which follows, and in part will be obvious from the description, or may be learned by practice. The features and advantages may be realized and obtained by means of the instruments and combinations particularly pointed out in the appended claims and aspects. These and other features will become more fully apparent from the following description and appended claims, or may be learned by the practice of the examples as set forth hereinafter.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, the present invention will be described and explained with additional specificity and detail through the use of the accompanying drawings in which:

FIG. 1 illustrates a wall display with a color selection kiosk mounted thereto, in accordance with the present invention;

FIG. 2 illustrates a top, right perspective view of the color selection kiosk shown in FIG. 1, albeit isolated from the wall display:

FIG. 3 illustrates a right, side view of the color selection kiosk;

FIG. 4 illustrates a bottom, plan view of the color reader component of the color selection kiosk; and

FIG. 5 illustrates an exploded view of the digital device and related assembly components used in the color reader component.

### DETAILED DESCRIPTION

The present invention provides systems, methods, and computer program products corresponding to a color selection kiosk that enables ordinary end users to use otherwise cost-prohibitive color reading instrumentation. The color selection kiosk can comprise a kiosk body having a substantially wedge-shaped structure, where the web-shaped structure comprises a front surface and a back surface that form an acute angle at a bottom of the kiosk body. A holder in the form of an extension arm extends from the front surface of the kiosk body, and provides a physical attachment for both a digital display device and for a color reader.

The kiosk body, digital display device and digital (i.e., electronic) color reader, including additional folders and accessories as noted herein can provide an end user with a convenient and ergonomic interface. The physical, kiosk interface enables a user to walk up to the kiosk, present an item of interest, whether from the store, or from home, and quickly identify one or more colors of the item, including identifying digital data corresponding thereto that is displayed on an electronic interface on the digital display device. The position, orientation, and location of each of the items disclosed herein can be optimized for ease of view and interaction, as well as providing safeguards to ensure devices remain powered and secured in position to prevent theft.

As described more fully herein, a color identification instrument such as color reader 130 (with corresponding lid 131) may be held at its base by a metal clasp, as shown in the Figures. As described more fully herein, the color identification instrument (e.g., 130) may alternatively comprise an embedded instrument. The metal clasp can be tightened/or loosened on the color reader 130 with an allen key/wrench by two grub screws on either side. The fasteners applied in this way can make it difficult to steal the digital device (260) enclosed in the casing 220. The fasteners and casing, as described herein, nevertheless provide a simple mechanism that can enable an employee to replace the digital device. In one example, the metal clasp holding the color reader 130 can be attached to a 3 mm stainless steel tether, which can run to the back of the wedge. This tether and clasp system, as described more fully herein, can provide additional strength, making it difficult to rip or pull the color reader 130 from the wall system 100 or wall display 120. The metal clasp also allows the color reader 130 to be charged by and connected to the base/kiosk body (105) illustrated herein. The digital display 260 can also be connected to a tether, which runs to the back of the kiosk body wedge, thus enabling the color reader 130 and digital display device 260 to remain plugged in for power, and allowing the color reader and/or digital display device to be on charge at all times in store.

As further described herein, both the tether and the color reader 130 electrical connections (e.g., USB, charging cable, etc.) can be encased by a rubber tube 210 to avoid any cable exposure, entanglement and tampering. The rubber tube 210 can run in length for 1.5 m from the front of the display to the back of the kiosk body where it is plugged in to a power source. Of the 1.5 m total tubing length, in some cases only 500 mm of the tubing may be visible/accessible to the consumer, whereby such length may allow ease of use in the retail space while restraining the color reader 130 from hitting the floor, or falling to other key areas of the color wall display 120. The color reader 130 may alternatively be embedded without optional removal from the case 265. In an additional example, a small 200 mm long, 1 mm thick stainless steel tether can be attached to the metal clasp (enclosure 220) located at the base of the color reader 130, which connects to the kiosk body through the tubing 210. This can allow the illustrated color reader lid 131 to be close at all times adding extra protection to the color reader 130 on display. At least one benefit of having the color reader 130 connected to (or embedded with) the display 260 is that the color reader 130 can be charging at all times without any intervention needed. The lid 131 can also be attached to the reader by a metal tether, which allows the reader to be covered when not in use, adding an additional layer of protection.

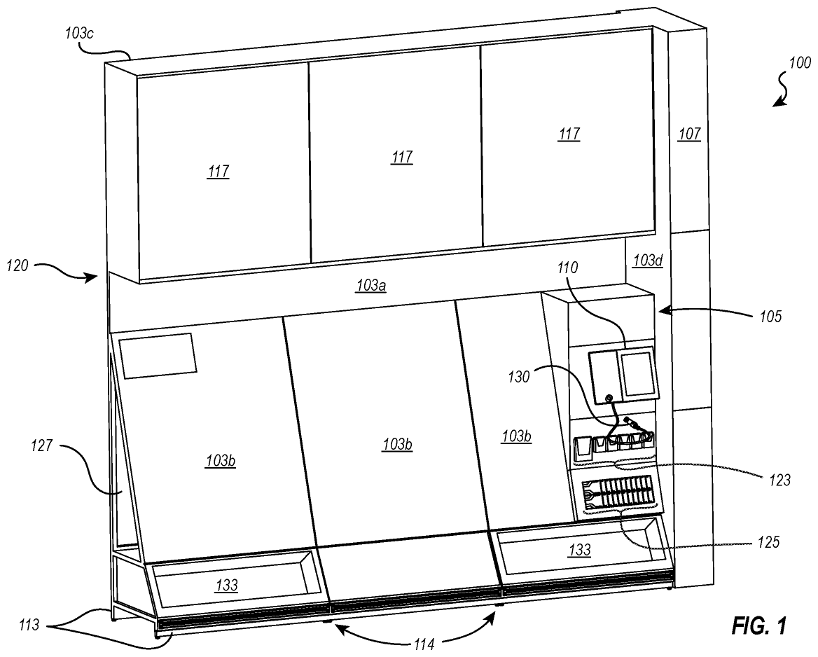

FIG. 1 illustrates a color selection system 100. FIG. 1 shows that color selection system 100 can comprise a wall display 120, which in turn comprises a plurality of surfaces joined together to form a standalone unit, and a kiosk body 105 attached thereto. For example, FIG. 1 shows that wall display 120 can comprise at least one planar surface 103a, and at least one angled surface 103b joined to a rear surface 103c, as well as various sidewall 107 surfaces 103d. The wall display 120 can further comprise one or more lower surfaces 113, which provide structural/floor support for the overall system 100. The one or more lower surfaces 113 can further comprise one or more footers 114, to assist in sliding and other floor support. The cavity 127 formed between the angled surfaces 103b and rear surface 103c can provide storage for electrical cables, or other supplies. The wall display 120 can be constructed from any number of materials including wood, aluminum, steel, plastics, rubber, and any other sufficiently rigid naturally occurring or synthetic materials, and/or combinations or composites thereof.

FIG. 1 also illustrates that the wall display 120 can comprise one or more cabinets 117 (or display boxes), and one or more cubbies 133, which can be used for various purposes, including storage and display. In one example, the one or more cabinets 117 comprise storage, whereas in one or more additional examples, the one or more cabinets 117 comprise light box displays that can be used to display various graphics, videos, or the like for use in informing users of available colors, paints, manufacturer information, end users, or other products. These and the other surfaces 103a, 103b can also be configured with graphic and video displays, and can alternatively be configured to display various color samples along a color spectrum, as well as coating manufacturer branding information.

One will appreciate that the angling of the angled surfaces 103b, and planar alignment of the surfaces 103a and cabinets 117 can provide ergonomically beneficial interactions with the system 100. For example, the upward angle of the angled surface 103b, and the planar face of the cabinets 117 and surfaces 103a can enable the user to view and interact with multiple surfaces of the wall display 120 visibly without having to bend over, crouch, or otherwise adjust the ordinary viewing position.

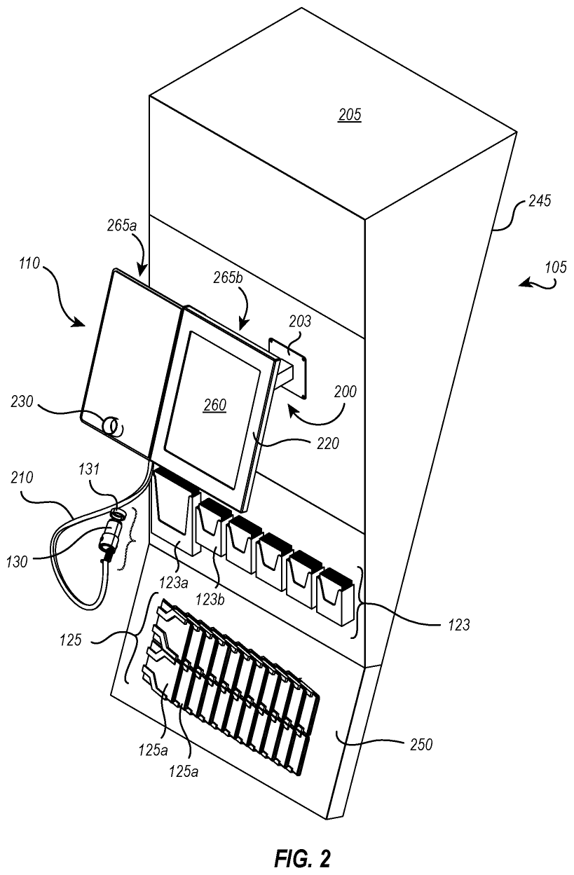

FIG. 1 further shows that the color selection system 100 can comprise a color selection kiosk 105 (or kiosk body) mounted to the wall display 120. As will be described further herein, the color selection kiosk 105 provides a color reader component 110. The color reader component 110 can be configured to provide a user with the ability to use a color reader 130 to identify one or more colors of a particular physical object or other form of color swatch presented to the reader, and display color options on a digital display (260, see FIGS. 2-5). FIG. 1 further shows that the color selection kiosk 105 is mounted to one or more of the angled surfaces 103b on the front, facing surface of the wall display 120. In at least one use case, the color selection kiosk 105 can be mounted to or placed against one or multiple different surfaces of the wall display 120, rather than the illustrated right-most angled surface 103b.

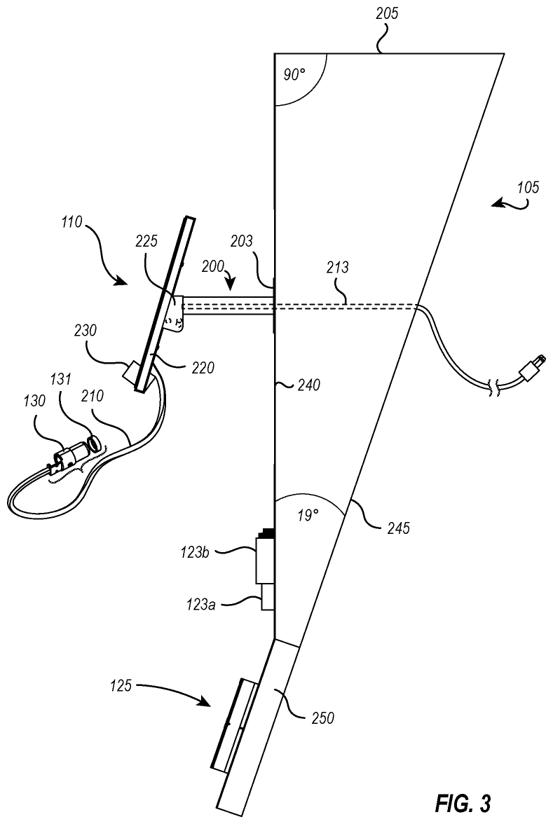

FIG. 2 provides additional details of the kiosk body 105 and color reader component 110. In particular, FIG. 2 illustrates a top, right perspective view of the color selection kiosk/kiosk body 105, as isolated from the wall display 120. In particular, FIG. 2 shows that the color selection kiosk 105 can comprise a top surface 205 joined by non-parallel surfaces, namely front surface 240, and rear surface 245. FIG. 2 shows that top surface 205 joins the top portions of the front surface 240 and rear surface 245, and that front surface 240 and rear surface 245 converge toward an angle at the lower end. In at least one example, the upper surface 205 of the kiosk is substantially parallel to the floor, and at least one angle between the front surface 240 or rear surface 245 is a right angle (see also FIG. 3).

As previously mentioned, FIG. 2 shows that the top/upper surface 205 forms a right angle with the front surface 240 of the color selection kiosk 105, while the angle between the top surface 205 and rear surface 245 is acute. In at least one example, the angle formed at the lower portion of the color selection kiosk 205 where planes of the front surface 240 and 245 converge is between approximately 150 to about 30°, preferably about 18° to 27°, or about 19°. In at least one example, the angle of the angled surface 103b of the wall display 120 is complementary to the angle of the rear surface 245 of the color selection kiosk 105, thus positioning the front surface 240 of the color selection kiosk 105 as substantially perpendicular to the floor.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has been described in terms of “a” digital device displaying “a” graphical user interface, one will appreciate that multiples of such devices and interfaces can be used and/or displayed, as applicable. When ranges are given, any endpoints of those ranges and/or numbers within those ranges can be combined within the scope of the present invention.

In addition, FIG. 2 illustrates that the color selection kiosk 105 can comprise an angled, lower portion 250, described more fully hereinafter. The materials forming the surfaces of the color selection kiosk 205 can comprise any number or combination of materials, including naturally-occurring or synthetic, sufficiently rigid materials including wood, plastics, metals, rubber, or composites and combinations thereof.

FIG. 2 further shows that the color selection kiosk 105 can comprise a number of different sub-components providing various different interactive features. For example, FIG. 2 (and each of the other Figures herein) shows that the color selection kiosk 105 can comprise a first set of folders 123 (or slots/holder), and a second set of folders 125 (or slots/holders). In at least one example, the first set of folders 123 can comprise any number or type of removable physical indicia that a user can take away for further evaluation. In at least one example, the physical indicia comprise color reference sheets, or color reader/color wheel reference sheets (e.g., COLOURSMITH reference sheets by PPG) that can be used in connection with another digital device to match or calibrate colors. The color reference sheets can comprise paper, or another suitable medium painted with an exemplary set of one or more colors

As with the first set of folders, the second set of folders may provide interactive color chips, such as described above, or more base line single color chips with mixing information, or other relevant color codes, whereas the color chips in the first folder may instead comprise color reference sheets, or other physical cards in the form of product information, or the like. In one or more additional examples, the color chips in the second set of folders or slots may further comprise various color codes that may be used by a mixer to mix paint of the displayed color. The physical indicia of the second set of folders or slots can also indicate to the user where to find the paint at a retail location. The second set of folders may be rotatable from side to side, so that the user can read information on opposing sides of the physical card within the given folder/slot. The physical cards in the first or second set of folders may be organized by color family, exemplary end uses, or the like.

FIG. 2 further shows that the color reader component 110 can comprise multiple color reader sub-components, generally presented to the user as a single, integrated unit. For example, FIG. 2 shows that the color reader component 110 can comprise essentially two sections, a color reader section 265a, and a digital display section 265b. As shown, the color reader section 265a can comprise a color reader mount 230, which in turn provides a rest or mount for a color reader 130. The color reader (or “digital color reader”), in turn, can comprise a spectrometer, colorimeter, spectrophotometer, or other form of color reader. By contrast, the digital display section 265b can comprise a case or enclosure 220 that securely encloses a digital display device 260. The digital display device 260 can comprise any form or type of personal digital device assistant, such as a digital tablet with a digital display that provides an interactive graphical user interface (not shown).

FIG. 3 illustrates a right, side view of the color selection kiosk 105 shown in FIGS. 1-2, which provides additional details for the color selection kiosk 105. For example, FIG. 3 illustrates that the casing/enclosure 220 used to hold the digital display device 260 can be attached to the arm 200 via one or more mounts 225. In one example, the mount 225 is rotatable, such as to enable the digital display device 260 enclosure 265b to tilt up or down to suit the end user. FIG. 3 also illustrates that one or more cables 213 can be fed through the color selection kiosk 105, one or more of which can terminate through the color reader 130 tubing 210. In at least one example, the tubing 210 extends approximately 1.5 m in length from the rear side of the color reader component 110 to attachment of the color reader 130.

Thus, the cables 213 can generally include at least one or more electrical cables, including power cables, or data cables (e.g., USB, HDMI, Firewire, Ethernet, etc.). The cables 213 can be used to power up and exchange data with the color reader 130 and digital display device 260. The one or more cables 213 can also include tethering cables (e.g., stainless steel) for further securement. In one example, the color reader 130 can be attached to the color selection kiosk 105 via one or more cables 213 that comprise a 3 mm stainless steel tether, also enclosed within the tubing 210. One or more other stainless steel tethers can also be used to secure the color reading case/enclosure 220 to the main kiosk body, i.e., to surfaces 240 and/or 245, as needed. As noted herein, the color reader 130 can alternatively be embedded without an extended tether that allows for detachment, such that an end user would just place the item of interest over the color reader or relevant sensor element in its embedded position. An embedded color reader or sensor may be directly connected to the display device 260, or connected wirelessly via BLUETOOTH or other wireless network connection means.

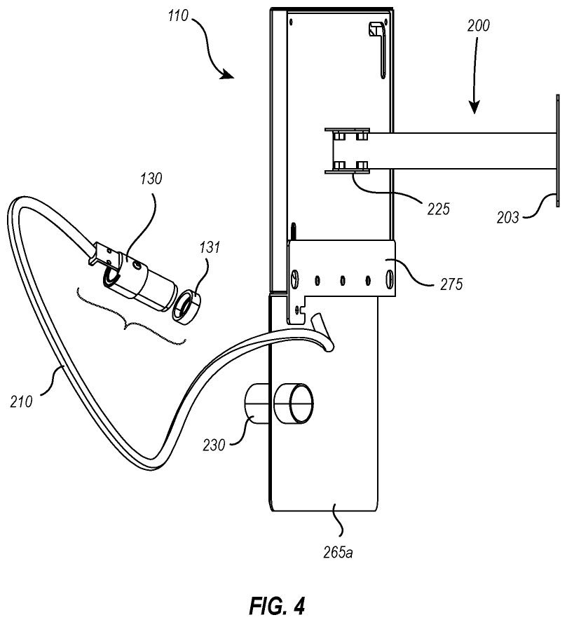

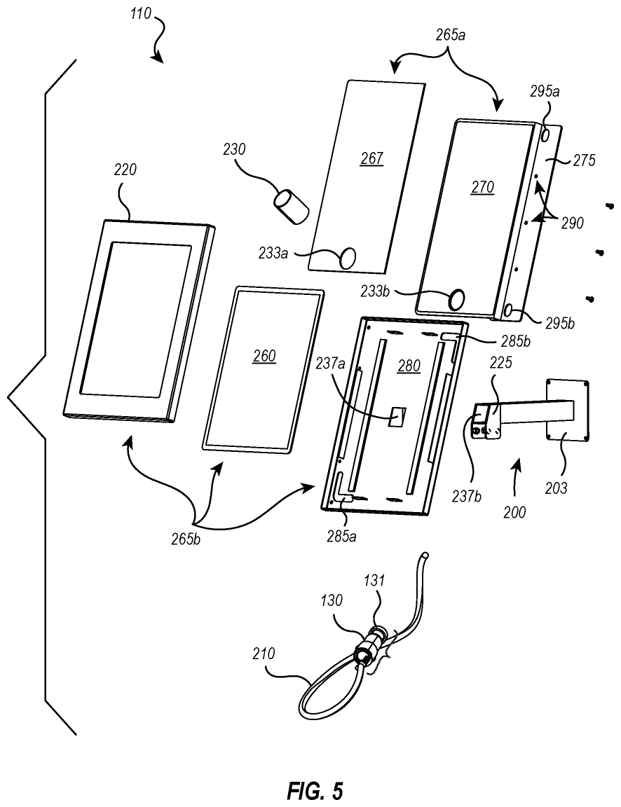

FIGS. 4 and 5 illustrate various views in assembled and exploded views of the color reader component 110 and corresponding sub-component, and are described together, as follows. For example, FIG. 4 shows that the arm mount 225 can be connected to a back plate 270 portion of the section 265b of the color reader component 110 on one side. FIGS. 4 and 5 further show that the arm 200 can be further connected to a mounting plate 203 on an opposing side. In general, the arm 200 can be designed to protrude from the front surface of the kiosk 105 at a specific angle and height for safe and easy consumer use.

FIG. 5 further shows that the color reader section 265a can comprise multiple other sub-components, including a face plate 267 comprising a first perforation 233a or through-hole for receiving the reader mount 230, and a backplate 270 that is also perforated with a through-hole 233b that aligns with perforation 233a. FIG. 5 further shows that the backplate 270 can comprise a lip 275 that itself can comprise one or more perforations 290 for receiving one or more fasteners. In addition, FIG. 5 shows that the lip 275 can also comprise one or more larger holes 295a, 295b, which may be used for fastening or venting purposes.

Furthermore, FIG. 5 shows that digital display section 265b can itself comprise multiple sub-components. For example, FIG. 5 shows that digital display section 265b can include the previously described case/enclosure 220, which attaches to a backplate 280 to cooperatively envelope and secure the digital display device 260 with various fasteners. In addition, FIG. 5 shows that the backplate 280 can comprise one or more through-holes 237a that align with a through-hole conduit 237b within the arm 200. In at least one example, the one or more cables 213 extend through arm 200 via the conduit/through-holes 237a and 237b. Additional perforations 285a and 285b provide alignment and venting for the digital display device 260.

Accordingly, one will appreciate in view of the enclosed specification and claims that the kiosk 105 can be designed in size and shape to be retrofit to any existing display wall, rather than just the illustrated wall display 120. Moreover, the various casing, cabling, and mounting components described herein enable use, display, securement, and continuous power of a any range of low to high-end digital devices 260 as a manufacturer may desire.

In one method of use, the manufacturer provides a color selection kiosk 105 as part of a system 100 at a retail space. A user can interact with the digital display by presenting an object to the color reader 130. The user can further interact with a graphical user interface provided through the digital display device 260. The digital display device 260 is continuously powered, and secure, enabling continuous use while preventing theft. As the user reads the object presented to the color reader 130, the digital display device 260 presents one or more matching colors, and color codes, and may also provide various complementary colors. The user can further observe various physical representations of colors, products, and other information through the physical materials presented via sections 123 and 125. The user can then use the information to obtain desired coatings for end use.

Accordingly, one or more embodiments or implementations of the present invention can provide several different advantages. For example, of the present invention that enable the color reader 130 and digital display 260 to be secured while continuously powered can enable the color reader 130 to remain on display without compromising its battery life. In addition, the described enclosures can provide a safe electric system in a retail space/store without exposing wires and charging cables to the consumer. The present examples can further provide the end user with the ability to handle and use the color reader without having the device unplug or lose power during operation. In addition, in cases where the color reader 130 is removable with a tether attachment, having the color reader on a tether at a precise length can allow both flexibility to maneuver the color reader without risk that the color reader will fall to the floor. Furthermore, the ease of assembly and disassembly of the enclosure apparatus can provide the ability to easily replace the color reader (e.g., in the event of aging or other damage) while still deterring theft.

In view of the foregoing, the present invention may be embodied in multiple different configurations, as outlined above, and as exemplified by the following aspects.

For example, in at least a first aspect, at least one configuration of the present invention includes a color selection kiosk for use at in a point-of-sale location, that includes a kiosk body having a top, a bottom, a planar back surface, and a front surface that is angled relative to the back surface, wherein the planar back surface and front surface form a wedge mounted against a support structure; a digital device displaying a graphical user interface, wherein the digital device is presented by a holder that extends from the front surface of the kiosk body; and a digital color reader communicably connected to the digital device; wherein: the color reader and the digital device are both physical secured and electronically connected to the kiosk body via the holder; and the color reader and the digital device are able to maintain continuous power for immediate use.

According to a second aspect of the color selection kiosk as recited in aspect one, the digital device can be mounted to the kiosk body so as to be positioned between about 1.2 m-1.7 m from the bottom of the kiosk body, preferably between about 1.3 m to about 1.6 m from the bottom of the kiosk body. In a third aspect, the color selection kiosk as recited in any of the preceding first through second aspects can further comprise one or more physical color displays mounted to the kiosk body; wherein the one or more physical color displays comprise one or more windows for displaying one or more color reference chips (as compared with digitally displayed color chips), the one or more color reference chips comprising physical color reference chips. According to a fourth aspect, in the color selection kiosk as recited in aspect 1, the one or more physical color displays are mounted to the kiosk body beneath the digital device.

According to a fifth aspect, in the color selection kiosk as recited in any of the preceding first through fourth aspects, the holder extends from the kiosk body by a length of between 13 cm-21 cm from the front surface of the kiosk body. According to a sixth aspect, in the color selection kiosk as recited in any of the preceding first through fifth aspects, the support structure comprises a color wall display. According to a seventh aspect, in the color selection kiosk as recited in any of the preceding first through sixth aspects, the kiosk body has a width of from about 40 cm to about 100 cm, preferably about 60 cm, and a height of from about 50 cm to about 200 cm, preferably about 108 cm. In an eighth aspect, in the color selection kiosk as recited in any of the preceding first through seventh aspects, the wedge is formed by a first plane corresponding to the front surface of the kiosk body, and a second plane corresponding to the back surface of the kiosk body; and the first plane and the second plane intersect at an angle between about 15 degrees and about 25 degrees, preferably about 19 degrees.

According to a ninth aspect, in the color selection kiosk as recited in any of the first through eighth aspects, the holder comprises an extension arm connected to the kiosk body on one end, and a display case on an opposing end. Ina tenth aspect, in the color selection kiosk as recited in any of the preceding first through ninth aspects, the display case of the extension arm comprises multiple sections; one section comprises a mount for the color reader; and an adjacent section comprises a mount for holding the digital device. In an eleventh aspect, in the color selection kiosk as recited in any of the preceding first through tenth aspects, the one or more physical color displays are mounted to the kiosk body beneath the digital device. In a twelfth aspect, in the color selection kiosk as recited in any of the first through eleventh aspects, the color reader and the digital device are directly, physically coupled to each other through the display case. According to a thirteenth aspect, in the color selection kiosk as recited in any of the first through twelfth aspects, the color reader and the digital device are directly coupled to an external power source via the holder arm.

According to a fourteenth aspect, another configuration of the present invention includes a color selection system for use at in a point-of-sale location includes a wall display comprising a plurality of surfaces joined to form a standalone unit, the plurality of surfaces further comprising a front side surface having with at least one planar surface and at least one angled surface, a kiosk body having a top, a bottom, a back surface, and a front surface that is angled relative to the back surface, wherein the planar back surface and front surface form a wedge mounted against a support structure; wherein the back surface of the kiosk body is mounted directly to either the angled surface or the planar surface of the wall display; a digital device displaying a graphical user interface, wherein the digital device is presented by a holder that extends from the front surface of the kiosk body; and a digital color reader communicably connected to the digital device; wherein: the color reader and the digital device are both physical secured and electronically connected to the kiosk body via the holder; and the color reader and the digital device are able to maintain continuous power for immediate use.

According to a fifteenth aspect, in the color selection system as recited in the fourteenth aspect, the wall display further includes a plurality of lower surfaces of the plurality of surfaces, wherein the plurality of lower surfaces directly and engage a floor to support the wall system. According to a sixteenth aspect, in the color selection system as recited in any of the preceding fourteenth through fifteenth aspects, the wall display further includes a side wall that is perpendicular to a top surface of the plurality of surfaces. According to a seventeenth aspect, in the color selection system as recited in any of the preceding fourteenth through sixteenth aspects, the angled surface of the plurality of surfaces of the wall display is positioned beneath the planar surface; and the kiosk body is mounted directly to the angled surface of the wall display. According to an eighteenth aspect, in the color selection system as recited in any of the preceding fourteenth through seventeenth aspects, the color reader includes an embedded sensor that is communicably connected to the digital device.

According to a nineteenth aspect, the color selection system as recited in any of the preceding fourteenth through eighteenth aspects, comprises the kiosk body as recited in any of the preceding first through thirteenth aspects. According to a twentieth aspect, in the color selection system or the color selection kiosk as recited in any of the preceding first through nineteenth aspects, the support structure is an angled surface or a planar surface of the wall display.

According to a twentieth-first aspect, in the color selection system or the color selection kiosk as recited in any of the preceding first through twentieth aspects, the color reader and the digital device are both physical secured and electronically connected to the kiosk body via the holder on the front surface of the kiosk body.

According to a twentieth-second aspect, in the color selection system or the color selection kiosk as recited in any of the preceding first through twentieth-first aspects, the holder is an extension arm connected to the kiosk body on one end, and a display case on an opposing end and the extension arm provides a conduit for electrical power, such as an electrical cable, to both the color reader and the digital display device.

According to a twentieth-third aspect, in the color selection system or the color selection kiosk as recited in any of the preceding first through twentieth-second aspects, the color reader is physical secured by a clasp attached to the color reader and a tether, preferably a steel tether, wherein the tether is attached to the color selection kiosk.

According to a twentieth-fourth aspect, in the color selection system or the color selection kiosk as recited in any of the preceding first through twentieth-third aspects, the digital device is physical secured by a case enclosing the digital device.

According to a twentieth-fifth aspect, in the color selection system or the color selection kiosk as recited in any of the preceding first through twentieth-fourth aspects, the color reader comprises a spectrometer, a colorimeter, and/or a spectrophotometer.

According to a twentieth-sixth aspect, in the color selection system or the color selection kiosk as recited in any of the preceding first through twentieth-fifth aspects, the digital device is physical secured by a case enclosing the digital device.

According to a twentieth-seventh aspect, in the color selection system or the color selection kiosk as recited in any of the preceding first through twentieth-sixth aspects, the color reader is electrically connected to the digital device, preferably via an electrical cable and/or data cable.

According to a twentieth-eight aspect, in the color selection system or the color selection kiosk as recited in any of the preceding first through twentieth-seventh aspects, the back surface of the kiosk body is attached to the upper surface of the kiosk body at an angle of 90° and the back surface of the kiosk body is attached to the upper surface of the kiosk body at an angle lower than 90°.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

We claim:

1. A color selection kiosk for use at in a point-of-sale location, comprising:
a kiosk body having a top, a bottom, a planar back surface, and a front surface that is angled relative to the back surface, wherein the planar back surface and front surface form a wedge mounted against a support structure;
a digital device displaying a graphical user interface, wherein the digital device is presented by a holder that extends from the front surface of the kiosk body; and
a digital color reader communicably connected to the digital device;
wherein:
the color reader and the digital device are both physical secured and electronically connected to the kiosk body via the holder; and
the color reader and the digital device are able to maintain continuous power for immediate use.

2. The color selection kiosk as recited in claim 1, wherein the digital device is mounted to the kiosk body so as to be positioned between 1.2 m-1.7 m from the bottom of the kiosk body, preferably between 1.3 m to 1.6 m from the bottom of the kiosk body.

3. The color selection kiosk as recited in claim 1, further comprising:
one or more physical color displays mounted to the kiosk body;
wherein the one or more physical color displays comprise one or more windows for displaying one or more color reference chips, the one or more color reference chips comprising physical color reference chips.

4. The color selection kiosk as recited in claim 1, wherein:
the one or more physical color displays are mounted to the kiosk body beneath the digital device.

5. The color selection kiosk as recited in claim 1, wherein:
the holder extends from the kiosk body by a length of between 13 cm-21 cm from the front surface of the kiosk body.

6. The color selection kiosk as recited in claim 1, wherein the support structure comprises a color wall display.

7. The color selection kiosk as recited in claim 1, wherein the kiosk body has a width of 60 cm and a height of 108 cm.

8. The color selection kiosk as recited in claim 1, wherein:
the wedge is formed by a first plane corresponding to the front surface of the kiosk body, and a second plane corresponding to the back surface of the kiosk body; and
the first plane and the second plane intersect at an angle between 15 degrees and 25 degrees, preferably 19 degrees.

9. The color selection kiosk as recited in claim 1, wherein the holder comprises an extension arm connected to the kiosk body on one end, and a display case on an opposing end.

10. The color selection kiosk as recited in claim 9, wherein:
the display case of the extension arm comprises a multiple sections;
one section comprises a mount for the color reader;
an adjacent section comprises a mount for holding the digital device.

11. The color selection kiosk as recited in claim 1, further comprising an information panel positioned just above the color reader.

12. The color selection kiosk as recited in claim 1, wherein the color reader and the digital device are directly, physically coupled to each other through the display case.

13. The color selection kiosk as recited in claim 1, wherein the color reader and the digital device are directly coupled to an external power source via the holder arm.

14. A color selection system for use at in a point-of-sale location, comprising:
a wall display comprising a plurality of surfaces joined to form a standalone unit, the plurality of surfaces further comprising a front side surface having with at least one planar surface and at least one angled surface,
a kiosk body having a top, a bottom, a back surface, and a front surface that is angled relative to the back surface, wherein the planar back surface and front surface form a wedge mounted against a support structure;
wherein the back surface of the kiosk body is mounted directly to either the angled surface or the planar surface of the wall display;
a digital device displaying a graphical user interface, wherein the digital device is presented by a holder that extends from the front surface of the kiosk body; and
a digital color reader communicably connected to the digital device;
wherein:
the color reader and the digital device are both physical secured and electronically connected to the kiosk body via the holder; and
the color reader and the digital device are able to maintain continuous power for immediate use.

15. The color selection system as recited in claim 14, wherein the wall display further comprises a plurality of lower surfaces of the plurality of surfaces, wherein the plurality of lower surfaces directly and engage a floor to support the wall system.

16. The color selection system as recited in claim 14, wherein the wall display further comprises a side wall that is perpendicular to a top surface of the plurality of surfaces.

17. The color selection system as recited in claim 14, wherein:
the angled surface of the plurality of surfaces of the wall display is positioned beneath the planar surface; and
the kiosk body is mounted directly to the angled surface of the wall display.

18. The color selection system as recited in claim 14, wherein:
the color reader comprises an embedded sensor that is communicably connected wirelessly to the digital device.
